(19) United States
(12) Patent Application Publication
(10) Pub. No.: US 2013/0343477 A9
(43) Pub. Date: Dec. 26, 2013

(54) PUSCH Reference Signal Design for High Doppler Frequency

(71) Applicant: RESEARCH IN MOTION LIMITED, Waterloo (CA)

(72) Inventors: Yongkang Jia, Ottawa (CA); Yi Song, Plano, TX (US); Yi Yu, Irving, TX (US); Chandra Sekhar Bontu, Nepean (CA); Zhijun Cai, Euless, TX (US)

(73) Assignee: RESEARCH IN MOTION LIMITED, Waterloo (CA)

(21) Appl. No.: 13/666,531

(22) Filed: Nov. 1, 2012

Related U.S. Application Data
(60) Provisional application No. 61/555,961, filed on Nov. 4, 2011.

(51) Int. Cl. H04J 11/00

(52) U.S. Cl. CPC H04J 11/00
USPC 375/295; 375/340

(57) ABSTRACT

A method is provided for communication in a wireless telecommunication system. The method comprises transmitting, by a UE, a DMRS, wherein REs carrying the DMRS are separated into a plurality of portions, each of the portions occupying a different OFDM symbol in a single slot of a radio subframe. In one aspect, a new PUSCH DMRS format may provide accurate channel estimates, increased RS density in the time domain at the expense of relaxed PAPR, and/or a symmetric pattern to ease the channel estimation algorithm. The PUSCH DMRS format may provide sufficient RS density in the time domain to enable accurate channel estimation for high Doppler scenarios.

### FIELD OF THE DISCLOSURE

The present disclosure relates to control channels in wireless telecommunications systems.

### BACKGROUND

As used herein, the term “user equipment” (alternatively “UE”) might in some cases refer to mobile devices such as mobile telephones, personal digital assistants, handheld or laptop computers, and similar devices that have telecommunications capabilities. Such a UE might include a device and its associated removable memory module, such as a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might include the device itself without such a module. In other cases, the term “UE” might refer to devices that have similar capabilities but that are not transportable, such as desktop computers, set-top boxes, or network appliances. The term “UE” can also refer to any hardware or software component that can terminate a communication session for a user. Also, the terms “user equipment,” “UE,” “user agent,” “UA,” “user device,” and “mobile device” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE). For example, an LTE system might include an Evolved Universal Terrestrial Radio Access Network (E-UTRAN) node B (eNB), a wireless access point, or a similar component rather than a traditional base station. Any such component will be referred to herein as an eNB, but it should be understood that such a component is not necessarily an eNB. eNBs, relays, wireless access points, and similar components may be referred to generically herein as access nodes or network elements.

LTE may be said to correspond to Third Generation Partnership Project (3GPP) Release 8 (Rel-8 or R8) and Release 9 (Rel-9 or R9), and possibly also to releases beyond Release 9, while LTE Advanced (LTE-A) may be said to correspond to Release 10 (Rel-10 or R10) and possibly also to Release 11 (Rel-11 or R11) and other releases beyond Release 10. As used herein, the terms “legacy”, “legacy UE”, and the like might refer to signals, UEs, and/or other entities that comply with LTE Release 11 and/or earlier releases but do not fully comply with releases later than Release 11. The terms “advanced”, “advanced UE”, and the like might refer to signals, UEs, and/or other entities that comply with LTE Release 12 and/or later releases. While the discussion herein deals with LTE systems, the concepts are equally applicable to other wireless systems as well.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an LTE resource grid in the case of a normal cyclic prefix, according to the prior art.

FIG. 2 illustrates a demodulation reference symbol (DMRS) inserted into an LTE resource grid, according to the prior art.

FIG. 3 is a graph depicting physical uplink shared channel (PUSCH) performance at a high Doppler frequency.

FIG. 4 is a graph identifying the dominant factor for PUSCH performance degradation.

FIG. 5 illustrates a PUSCH DMRS format, according to an embodiment of the disclosure.

FIG. 6 illustrates another PUSCH DMRS format, according to an embodiment of the disclosure.

FIG. 7 illustrates another PUSCH DMRS format, according to an embodiment of the disclosure.

FIG. 8 illustrates another PUSCH DMRS format, according to an embodiment of the disclosure.

FIG. 9 illustrates another PUSCH DMRS format, according to an embodiment of the disclosure.

FIG. 10 illustrates an example of an orthogonal cover code applied within one slot, according to an embodiment of the disclosure.

FIG. 11 illustrates another example of an orthogonal cover code applied within one slot, according to an embodiment of the disclosure.

FIG. 12 illustrates a transmitter structure for DMRS symbols, according to an embodiment of the disclosure.

FIG. 13 illustrates a receiver structure for DMRS symbols, according to an embodiment of the disclosure.

FIG. 14 illustrates a PUSCH-Config information element, according to an embodiment of the disclosure.

FIG. 15 illustrates block error rate (BLER) performance of uplink open-loop spatial multiplexing (SM) with a new DMRS format, according to an embodiment of the disclosure.

FIG. 16 illustrates BLER performance of uplink space-frequency block code (SFBC) with a new DMRS format, according to an embodiment of the disclosure.

FIG. 17 illustrates the performance of a new DMRS format at low speed, according to an embodiment of the disclosure.

FIG. 18 illustrates throughput performance of a PUSCH with a new DMRS format, according to an embodiment of the disclosure.

FIG. 19 illustrates a peak-to-average power ratio of a new DMRS format, according to an embodiment of the disclosure.

FIG. 20 illustrates a method for communication in a wireless telecommunication system according to an embodiment of the disclosure.

FIG. 21 is a simplified block diagram of an exemplary network element according to one embodiment.

FIG. 22 is a block diagram of an example user equipment capable of being used with the systems and methods in the embodiments described herein.

FIG. 23 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. Embodiments are described herein in the context of an LTE wireless network or system, but can be adapted for other wireless networks or systems.

A high Doppler frequency can occur in a signal transmitted between two entities when one of the entities is moving at a high speed relative to the other. More specifically, when a UE is moving at a high speed relative to an eNB, a high Doppler frequency can occur in the signals transmitted between the UE and the eNB. In such cases, the communication channel changes rapidly, and more reference signals may be needed in the time domain to enable accurate channel interpolation and estimation. However, the uplink reference signal design in current LTE systems does not provide sufficient reference signal density for high Doppler frequency situations, and therefore the data throughput may be degraded in such situations due to inaccurate channel estimation. Embodiments of the present disclosure provide new DMRS formats that significantly increase the reference signal density in the time domain and enhance the channel estimation which in turn improve the data throughput. In these embodiments, the same reference signal overhead is maintained as in the legacy reference signals, and the increase in peak-to-average power ratio (PAPR) is minimized.

Some background information regarding LTE subframes, uplink data channels, and Doppler effects may be helpful in describing the embodiments disclosed herein.

Each subframe within an LTE radio frame can include a number of orthogonal frequency division multiplexing (OFDM) symbols in the time domain and a number of subcarriers in the frequency domain. An OFDM symbol in time and a subcarrier in frequency together define a resource element (RE). A resource block (RB) can be defined as, for example, 12 consecutive subcarriers in the frequency domain and all the OFDM symbols in a slot in the time domain. There are two slots in a subframe. An RB pair with the same RB index in slot 0 and slot 1 in a subframe can be allocated together.

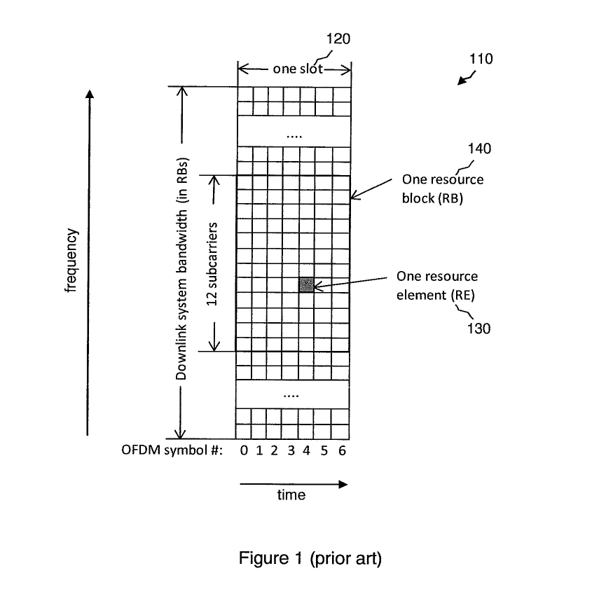

FIG. 1 shows an LTE resource grid 110 within a slot 120 in the case of a normal cyclic prefix (CP) configuration. The figure refers to a downlink system, but a similar grid would be used in the uplink. Each element in the resource grid 110 is an RE 130, which is uniquely identified by an index pair of a subcarrier and an OFDM symbol in the slot 120. An RB 140 includes a number of consecutive subcarriers in the frequency domain and a number of consecutive OFDM symbols in the time domain, as shown in the figure. An RB 140 is the minimum unit used for the mapping of certain physical channels to REs 130.

The physical uplink shared channel (PUSCH) is used to carry uplink data and could be used to carry uplink control information (UCI) as well. Prior to Rel-10, single carrier frequency division multiple access (SC-FDMA) was adopted for PUSCH transmission due to its low PAPR. A low PAPR is important for uplink (UL) transmission as it requires less power backoff and in turn extends uplink coverage and saves UE power. SC-FDMA can also be viewed as discrete Fourier transform (DFT)-precoded OFDM with contiguous resource allocation. SC-FDMA applies a DFT operation to an input data stream and maps the DFT-precoded data to a set of contiguous subcarriers.

In Rel-10, to improve the UL throughput while still maintaining a reasonably low PAPR, DFT-precoded OFDM with non-contiguous resource allocation (also known as clustered DFT-precoded OFDM) was introduced. A single DFT is applied to an input data stream and the DFT-precoded data is mapped to up to two non-contiguous RB clusters. Compared to SC-FDMA, the flexible resource allocation in clustered DFT-precoded OFDM improves throughput performance.

In addition, prior to Rel-10, only single-antenna port transmission was supported for the PUSCH. In Rel-10 and later releases, both single-antenna port and multiple-antenna port transmissions are supported. Up to four antenna ports can be used, and uplink spatial multiplexing of up to four layers is enabled.

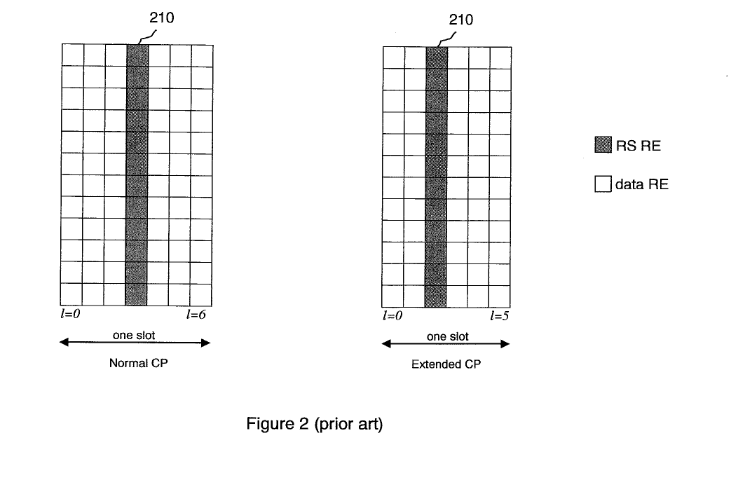

To facilitate channel estimation and data decoding, a demodulation reference signal (DMRS) is inserted into the PUSCH. Due to the DFT-precoded OFDM transmission scheme, the DMRS occupies an entire OFDM symbol within the PUSCH resource allocation. As shown in FIG. 2, the DMRS 210 occupies the third OFDM symbol in a slot for a normal CP and the second OFDM symbol in a slot for an extended CP. (Herein, the term “zeroth OFDM symbol in a slot” refers to OFDM symbol #0, the term “first OFDM symbol in a slot” refers to OFDM symbol #1, and so on.)

To maintain a low PAPR, DMRS is based on a Zadoff-Chu sequence, which is a non-binary unit-amplitude sequence satisfying a constant amplitude zero autocorrelation (CAZAC) property. With a Zadoff-Chu sequence, a reference signal (RS) may maintain a constant amplitude in the time domain, which provides a low PAPR. A constant amplitude in the frequency domain may also be maintained, which equally excites the allocated subcarriers to provide equal channel estimation performance across all the subcarriers. In addition, zero circular autocorrelation may be used for accurate channel estimation. There may also be a low cross-correlation between two sequences, which reduces interference from an RS transmitted by another UE on the same RBs.

The Zadoff-Chu sequence is directly applied to the RS REs without DFT precoding. The RS sequence r_{u,v}^{(α)}(n) is generated from a base sequence r̅_{u,v}(n) with a cyclic shift a

r_{u,v}^{(α)}(n)=e^{jαn} r̅_{u,v}(n), 0≦n<M_{sc}^{RS}

where M_{sc}^{RS} is the length of the RS sequence. Multiple RS sequences can be generated from a single base sequence through different cyclic shifts. The same group number u and sequence number v are used by all UEs in the cell. The cyclic shift α is determined by the cyclic shift field in the uplink grant.

In the case of Rel-10 non-contiguous resource allocation, one RS sequence is generated with a length equal to the total number of subcarriers of two RB clusters. In the case of uplink spatial multiplexing in Rel-10, the DMRS is precoded using the same precoder as the PUSCH. To maintain orthogonality among the DMRSs from multiple layers, CDM (code division multiplexing) is adopted and different layers use different cyclic shifts of the same base sequence.

In the case of UL multi-user multiple input multiple output (MU-MIMO), if two UEs are assigned the same RBs, different cyclic shifts can be used to separate the DMRS from the two UEs. If two UEs are assigned different RBs, the orthogonality between the two DMRSs cannot be achieved by cyclic shift separation, as the two UEs use two different base sequences with different lengths. To solve this issue, time domain orthogonal cover code (OCC) was introduced in Rel-10 with the orthogonal codes {+1, +1} and {+1, −1} spanning the DMRSs in the two slots of a subframe. As a result, in MU-MIMO, the two UEs will be assigned different OCCs to separate the DMRSs. OCC is also applied to the DMRSs of uplink spatial multiplexing, with the first and second layers using one OCC and the third and fourth layers using another OCC.

Doppler frequency is caused by a relative movement between a transmitter and a receiver. The Doppler frequency is calculated as

$${f}_{d} = \frac{v}{c} {f}_{c} ,$$

, where v is the relative speed between the transmitter and the receiver, c is the speed of light, and f_{c} is the carrier frequency. In a wireless system, a high Doppler frequency could be caused by a high UE speed and/or a high carrier frequency. Under a high Doppler frequency, the channel changes rapidly in the time domain, which poses challenges on channel estimation and in turn may reduce data throughput.

There are a number of use cases in which a high Doppler frequency could occur. For example, as the demand for wireless traffic in cellular networks has increased with the popularity of smart phones, the existing frequency bands may be inadequate. One of the solutions to this spectrum scarcity problem is to use higher frequency bands, which could provide a significant amount of new spectrum. As another example, a UE on a high-speed train could move at a speed of 350 kilometers per hour (km/h) or even higher. As yet another example, it has been envisioned that mobile relays could be mounted on high-speed public transportation systems, such as trains moving at 350 km/h or even 500 km/h. In such cases, a high Doppler frequency may be expected to occur on the relay backhaul between the macro eNB and the mobile relay.

A high Doppler frequency may cause a number of issues. For example, under a high Doppler frequency, the channel changes rapidly in the time domain. For OFDM systems to function properly, the channel may need to be approximately constant within one OFDM symbol to maintain orthogonality among OFDM subcarriers. A fast changing channel under a high Doppler frequency may cause the channel to vary within one OFDM symbol and may break the orthogonality among subcarriers. The break in orthogonality may introduce inter-carrier interference (ICI), which in turn may reduce the signal to interference and noise ratio (SINR) on data REs and hence limit the data throughput. In addition, channel estimation is particularly challenging under a high Doppler frequency. First, due to ICI, the channel estimates at RS REs may not be accurate. Second, the channel estimates on data REs are typically obtained via interpolation from channel estimates on RS REs. Due to the fast changing channel in the time domain, a high RS density in the time domain may be required so that the interpolation operation can produce accurate channel estimates. An inaccurate channel estimation may increase the packet detection error rate and reduce data throughput. The inaccurate channel estimation may also give an inaccurate channel quality indicator (CQI) estimation and may pose challenges on link adaption, which may further reduce data throughput.

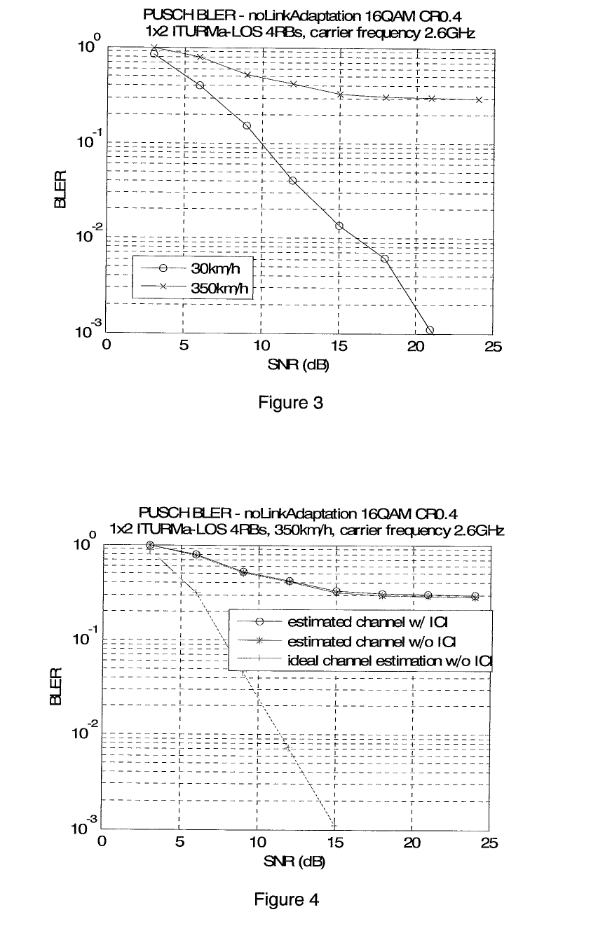

FIG. 3 illustrates PUSCH performance at a high Doppler frequency. A carrier frequency of 2.6 gigahertz (GHz) is assumed. A packet block error rate (BLER) of 16 quadrature amplitude modulation (16QAM) and code rate (CR) 0.4 with real channel estimation and one antenna port transmission is simulated. It can be observed that the BLER is significantly degraded at 350 km/h, with an irreducible error floor higher than 10%. Furthermore, such a serious degradation starts even from a moderate modulation and coding scheme (MCS) level such as 16QAM CR 0.4.

The performance degradation could be due to ICI and/or insufficient RS density in the time domain. To identify the dominant factor, FIG. 4 compares the BLERs of the PUSCH for the following three cases: (1) a perfectly known channel without ICI, (2) an estimated channel without ICI, and (3) an estimated channel with ICI. In the case of the simulations without ICI, it may be assumed that the channel is unchanged within one OFDM symbol. A significant performance gap may be observed between cases 1 and 2, which indicates that the dominant degradation factor is the insufficient RS density.

In the current LTE design, the DMRS of the PUSCH is placed in the middle of the slot, and there is one DMRS symbol per slot. Hence, the RS density in the time domain is quite low. This RS arrangement is adequate for scenarios of low to medium Doppler frequency. However, in the case of high Doppler frequency, the current DMRS density may not be sufficient for the receiver to perform an accurate channel interpolation in the time domain. To improve PUSCH performance at a high Doppler frequency, it may be necessary to increase the DMRS density in the time domain.

A straightforward method for increasing the DMRS density in the time domain is to add more of the current DMRS in the time domain. However, this may cause excessive overhead and significantly reduce the data throughput, as each DMRS occupies an entire OFDM symbol within the PUSCH. The whole-symbol RS design is inherited from the Rel-8 UL SC-FDMA, as in Rel-8 a low PAPR was considered a priority in UL design. As mentioned above, Rel-10 introduced additional UL transmission modes, such as clustered DFT-precoded OFDM and simultaneous PUSCH and physical uplink control channel (PUCCH). These modes enhanced throughput but slightly increased PAPR.

Embodiments of the present disclosure take advantage of the relaxed PAPR requirements in Rel-10 to provide new PUSCH DMRS formats that increase the RS density in the time domain with only a slight increase in PAPR. The disclosed DMRS formats provide accurate channel estimates and a sufficient RS density in the time domain at a relatively low PAPR. The same RS overhead is maintained as in the legacy RS. A symmetric RE pattern is provided to ease the channel estimation algorithm. The last OFDM symbol in a subframe is not occupied to ensure proper sounding reference signal (SRS) transmission. In addition, the new DMRS formats entail minimal changes to existing specifications and minimize the impact on UE transmitters and eNB receivers.

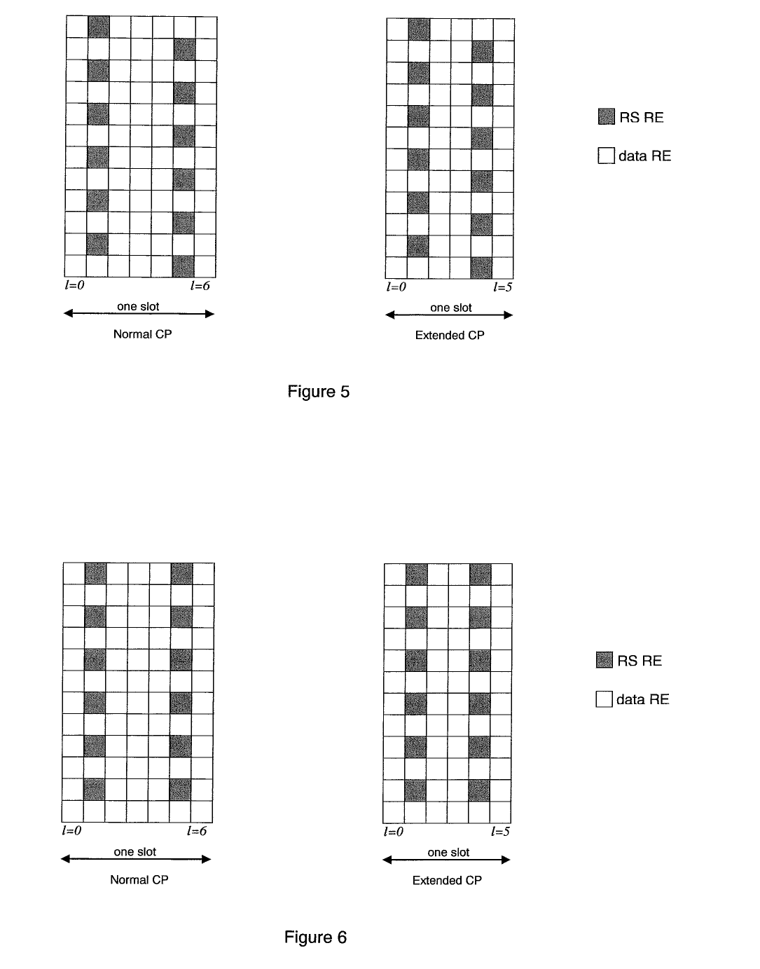

FIG. 5 shows an example of one of the new DMRS formats. In the case of normal CP, the DMRS occupies the even subcarriers of the first OFDM symbol and the odd subcarriers of the fifth OFDM symbol in the slot. In the case of extended CP, the DMRS occupies the even subcarriers of the first OFDM symbol and the odd subcarriers of the fourth OFDM symbol. The REs that are not used for the DMRS in these OFDM symbols are used for data transmission. In the case of uplink spatial multiplexing, the RSs of multiple layers are multiplexed by CDM on the RS REs as in the current LTE system. The same RS pattern is repeated in the second slot of a subframe. This new DMRS format has the same amount of overhead as the current DMRS but with twice the density in the time domain. In addition, the new DMRS symbol has the same numerology as the data symbol.

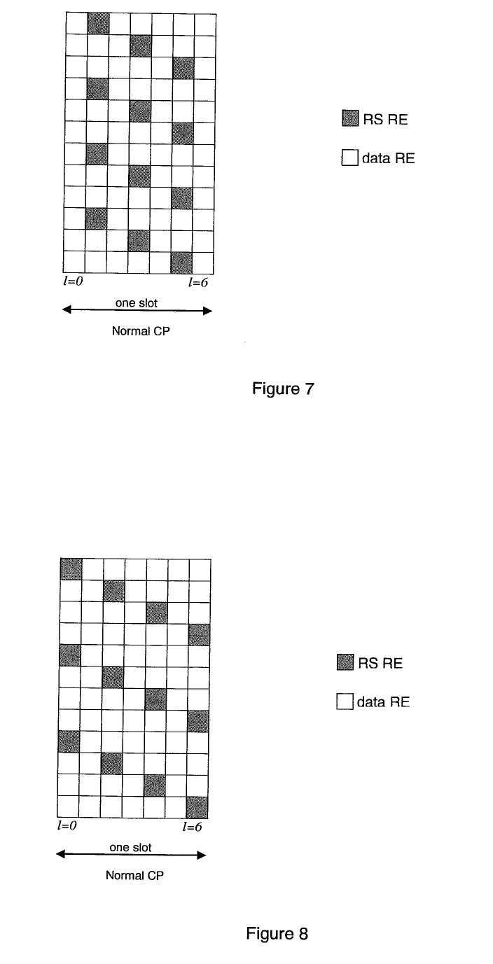

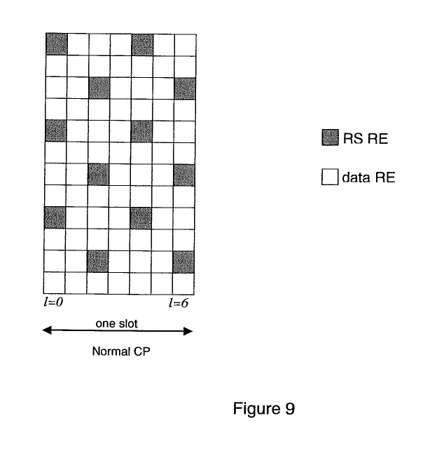

FIG. 6 shows another example of the new DMRS format in which the RS REs occupy the same set of subcarriers in the two DMRS symbols in a slot. Another example of the new DMRS format is shown in FIG. 7, where the RS REs are placed in every third RE on OFDM symbols 1, 3, and 5. As in FIG. 5, the RS REs on different OFDM symbols are offset by one subcarrier in FIG. 7, but such an offset is not necessarily the case, as can be seen in FIG. 6. FIG. 8 and FIG. 9 show another two examples of the new DMRS format. The DMRS patterns in FIG. 7, FIG. 8, and FIG. 9 have high RS densities in the time domain but at the cost of slightly higher PAPRs than the patterns in FIG. 5 and FIG. 6.

In general, all of the DMRS formats in FIGS. 5 through 9 may be said to consist of a DMRS in which the REs carrying the DMRS are separated into a plurality of portions, and each of the portions occupies a different OFDM symbol in a single slot of a radio subframe. In the OFDM symbols occupied by the portions, REs that are not used for carrying the DMRS are used for carrying data.

In the DMRS formats of FIGS. 5 and 6, the REs carrying the DMRS are separated into two portions with six REs in each portion. In FIG. 5, REs in a first portion occupy the even numbered subcarriers in the slot and REs in a second portion occupy the odd numbered subcarriers in the slot. In FIG. 6, REs in each portion occupy the same subcarriers, and the subcarriers carrying the DMRS are separated by a subcarrier carrying data. In FIGS. 5 and 6, OFDM symbols carrying the DMRS are separated by at least two OFDM symbols carrying data. In general, each portion of the DMRS can occupy any OFDM symbol that is not occupied by the other portion within the slot. Furthermore, each portion of the DMRS may occupy a different OFDM symbol in the first and second slots of a radio subframe.

In the DMRS format of FIG. 7, the REs carrying the DMRS are separated into three portions with four REs in each portion. All of the REs carrying the DMRS occupy different subcarriers. OFDM symbols carrying the DMRS are separated by at least one OFDM symbol carrying data. In general, each portion of the DMRS can occupy any OFDM symbol that is not occupied by the other portion within the slot. Furthermore, each portion of the DMRS may occupy a different OFDM symbol in the first and second slots of a radio subframe.

In the DMRS formats of FIGS. 8 and 9, the REs carrying the DMRS are separated into four portions with three REs in each portion. In FIG. 8, all of the REs carrying the DMRS occupy different subcarriers. In FIG. 9, REs in two of the portions occupy subcarriers starting from the first subcarrier, REs in another two of the portions occupy subcarriers starting from the second subcarrier, and the subcarriers occupied with DMRS are separated by subcarriers carrying data. In FIGS. 8 and 9, OFDM symbols carrying the DMRS are separated by at least one OFDM symbol carrying data. In general, each portion of the DMRS can occupy any OFDM symbol that is not occupied by the other portion within the slot. Furthermore, each portion of the DMRS may occupy a different OFDM symbol in the first and second slots of a radio subframe.

The average power of the DMRS may be adjusted compared to the average power of the data REs such that the PAPR on the OFDM symbols in which the DMRS is present is reduced. However, this power boosting may be possible only when the data is quadrature phase shift keying (QPSK) modulated.

The description of the mapping of RS to physical resources in the current LTE specification may need to be modified for the new DMRS format. As an example, for the DMRS pattern in FIG. 5, the mapping of RS to physical resources in Section 5.5.2.1.2 of 3GPP TS 36.211 may be modified as follows:
The mapping to resource elements (k, l) with l=1, 5 for normal cyclic prefix and l=1,4 for extended cyclic prefix, and k=k₁, k₁+2, k1+4, . . . , K−2+k₁ in the subframe shall be in the increasing order of k, then the slot number. K represents the number of PUSCH subcarriers. k1=0 for l=1 and k₁=1 for l=4 or 5 for normal or extended cyclic prefix.

To reduce inter-cell interference at the DMRS symbols, eNBs may coordinate the uplink data resource allocation for different UEs in such a way that high-speed UEs are allocated at the same frequency resource with different DMRS sequence cyclic shifts. Alternatively, a specific frequency resource may be reserved for uplink high-speed UEs that will be used among neighboring eNBs.

Sequence generation for the new DMRS format is similar to that for the current DMRS but with a different sequence length. For example, for the new DMRS formats in FIG. 5 and FIG. 6, the sequence length is half of the number of PUSCH subcarriers. The same RS sequence is applied to the two OFDM symbols in the slot. The RS sequence generation in Section 5.5.1 of 3GPP TS 36.211 may be modified as follows:
Reference signal sequence r_{u,v}^{(α)}(n) is defined by a cyclic shift α of a base sequence r̅_{u,v}(n) according to

r_{u,v}^{(α)}(n)=e^{jαn} r̅_{u,v}(n), 0≦n<M_{sc}^{RS}

where M_{sc}^{RS} is the length of the RS sequence, which is half of the number of PUSCH subcarriers.

For RS lengths >=12, the base sequence is generated in the same way as currently described in Sections 5.5.1.1 and 5.5.1.2 of 3GPP TS 36.211.

In the case of one-RB PUSCH allocation, RS sequences with length 6 may be needed but are not supported by the current LTE specifications. To solve this issue, a computer search method may be used to generate 30 base sequences with length 6. Since there are only six available cyclic shifts, the RS cyclic shift generation procedure in Section 5.5.2.1.1 of 3GPP TS 36.211 may be modified as follows:

The cyclic shift α_{λ} in a slot nₛ is given as α_{λ}=2πn_{cs,λ}/6 with

n_{cs,λ}=(n_{DMRS}⁽¹⁾+n_{DMRS,λ}⁽²⁾+n_{PN}(nₛ))mod 6

That is, the denominator in the above equation of α_{λ} is 6, whereas the denominator in the equivalent equation in the current LTE specification is 12. The modulo operation in the above equation of n_{cs,λ} is with respect to 6, whereas in the equivalent equation in the current LTE specification it is 12.

In the case of one-RB allocation with uplink spatial multiplexing, to achieve better channel estimation, it may be preferred to support up to two layers with cyclic shifts for two layers being {0,3}, {1,4}, or {2,5} due to the limited number of available RS sequences.

In another embodiment, to minimize the specification change for one-RB allocation, when the new DMRS format is used, the eNB may assign a minimum resource allocation of two RBs. For applications such as the mobile relay backhaul, the minimum two-RB allocation may not be an issue, as the backhaul link typically needs a large-bandwidth resource allocation. For small-data applications such as VoIP, some resource waste could occur. Power-limited, cell-edge UEs, which may only support one RB, may not be assigned to use the new DMRS format.

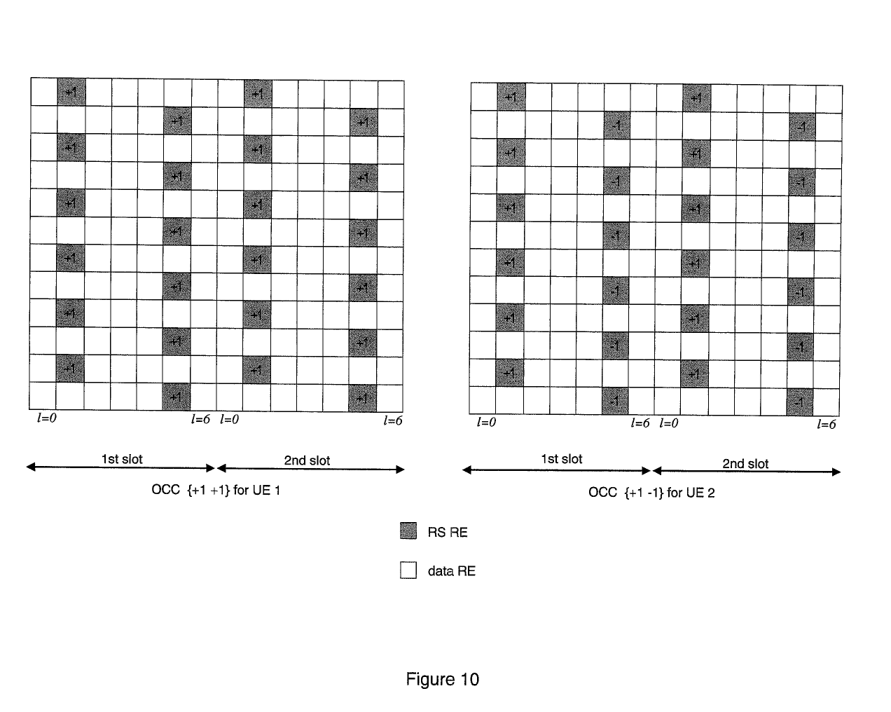

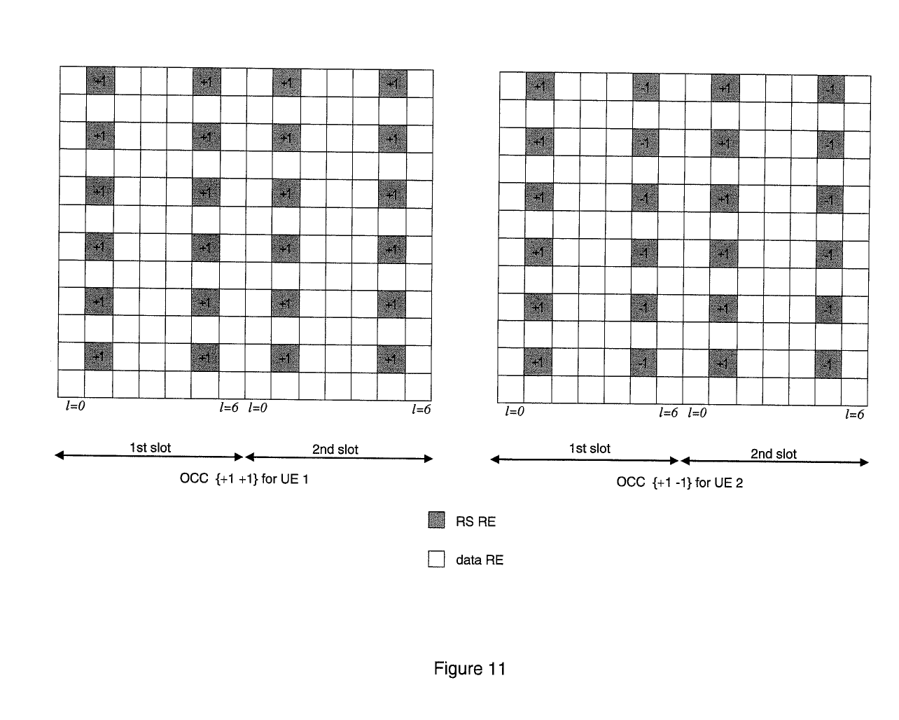

In the case of UL spatial multiplexing and MU-MIMO, in Rel-10 time-domain OCC is applied across the two DMRS symbols in two slots. For the new DMRS formats of FIG. 5 and FIG. 6, OCC may be applied to the two DMRS symbols within one slot, and the same OCC may be repeated in the second slot of the subframe. Examples are shown in FIG. 10 and FIG. 11.

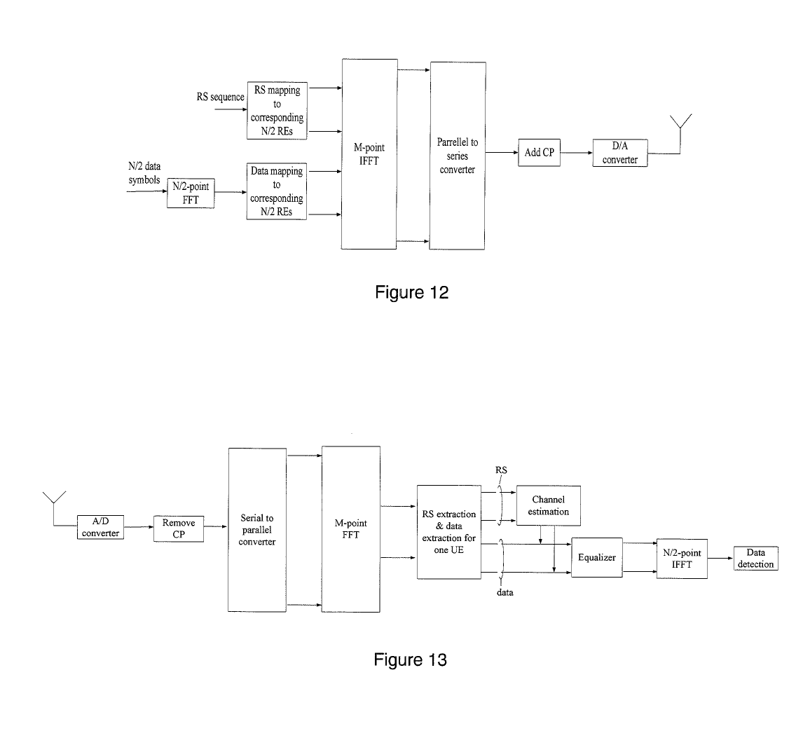

The UE transmitting process may need to be modified to accommodate the new DMRS format. As shown in FIG. 12, data and RS are interleaved in an OFDM symbol that contains DMRS. For the DMRS patterns in FIG. 5 and FIG. 6, the data will undergo N/2-point FFT/DFT, where N is the number of PUSCH subcarriers. The DFT precoded data is mapped to the REs which are not used for DMRS. The multiplexed RS and data will undergo M-point IFFT, where M is the IFFT size corresponding to the system bandwidth. For example, M=2048 for a 20 MHz bandwidth. For DMRS patterns in FIG. 7, the data transmitted on the OFDM symbols which consist of DMRS symbols will be DFT precoded with a 2N/3-point FFT/DFT before being mapped on to the REs which are not used for DMRS. Similarly, for DMRS patterns in FIG. 8 and FIG. 9, the data transmitted on the OFDM symbols which consist of DMRS symbols will be DFT precoded with a 3N/4-point FFT/DFT before being mapped on to the REs which are not used for DMRS.

The receiving process at the eNB may also need to be modified for the new DMRS format. As shown in FIG. 13, for the DMRS patterns of FIG. 5 and FIG. 6, during an OFDM symbol that contains DMRS, after M-point FFT occurs, data and RS are extracted from the corresponding REs. The RS is used for channel estimation, and the obtained channel estimates are used for channel equalization and data detection.

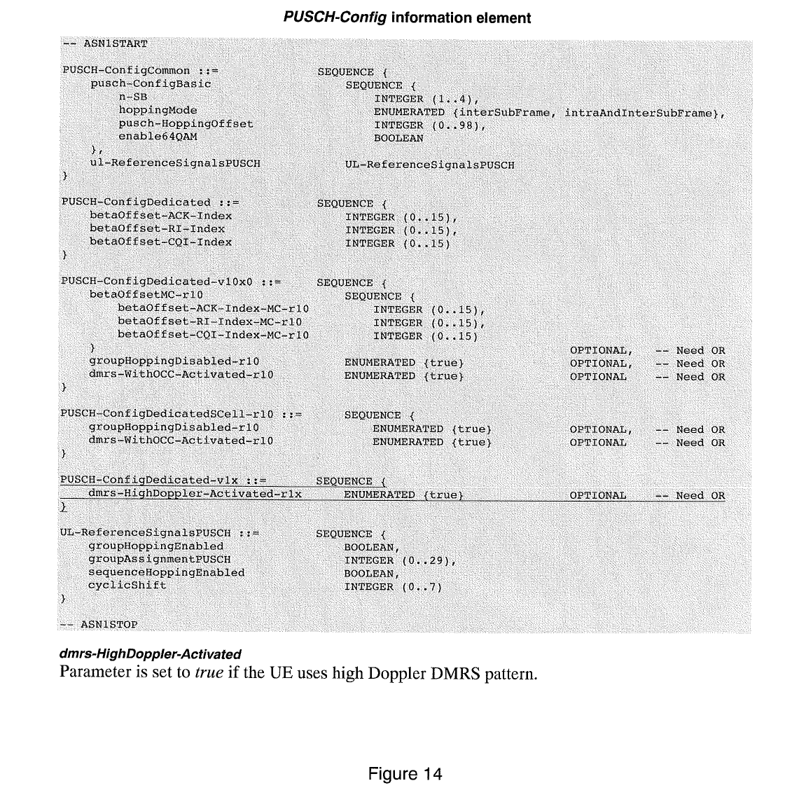

The new DMRS format may be semi-statically enabled by higher layer radio resource control (RRC) signaling. For example, as shown by the underlined portion of FIG. 14, a one-bit parameter, referred to in the figure as dmrs-HighDoppler-Activated, may be introduced in the PUSCH-ConfigDedicated information element (IE) to specify the UE-specific PUSCH configuration. For high-Doppler UEs or mobile relays, the eNB enables the dmrs-HighDoppler-Activated parameter, and the new DMRS format is used for PUSCH transmission. If multiple possible DMRS patterns are available for different levels of trade-off between channel estimation accuracy and PAPR, then a multiple-bit version of the dmrs-HighDoppler-Activated parameter is possible as well. In this case, the dmrs-HighDoppler-Activated parameter indicates which pattern is to be used. The eNB may also disable the utilization of the new DMRS format. That is, the eNB may estimate the Doppler frequency, based on CP for example, and determine whether the new DMRS format is needed. If the Doppler frequency is increased or reduced and the new DMRS format needs to be turned on or off, the eNB sends an RRCConnectionReconfiguration message which includes the PUSCH-ConfigDedicated IE to enable or disable the dmrs-HighDoppler-Activated parameter.

In another alternative, the activation or deactivation of the new DMRS format may be triggered by a request from a UE. If a UE, for example a UE on a high-speed train, has some knowledge that its speed is high and/or that the uplink transmission performance may be poor for some time, the UE may request the eNB to assign the new DMRS format. When the eNB assigns the new DMRS format, the eNB may also include an activation time to ensure the start of the usage of the new DMRS format. In other alternatives, the new DMRS format may be triggered by a medium access control (MAC) control element.

When a handover of a UE occurs, information regarding the new DMRS format may need to be exchanged between the eNBs involved in the handover. In addition, the target eNB signals the dmrs-HighDoppler-Activated parameter to the UE in the handover Command message so that the UE can continue to use the new DMRS format when moving from one cell to another cell. In this way, the handover may occur smoothly without deactivation and reactivation of the new DMRS format. Signaling the dmrs-HighDoppler-Activated parameter in this manner may also improve the data throughput during the handover, considering the fact that handovers may occur often for a UE on a high-speed train. In such cases, even Message 3 of the random access in the handover procedure may use the new DMRS format for improved performance.

Alternatively, if the eNB is exclusively used for high-speed trains, the dmrs-HighDoppler-Activated parameter may be set as a system parameter in the PUSCH-ConfigCommon IE.

For fast enablement and disablement, a DMRS format indicator may also be signaled in Layer 1 UL grants in a way similar to the signaling of a DMRS cyclic shift. One additional bit may be added in downlink control information (DCI) format 0 or DCI format 4 to indicate whether the new DMRS format is enabled or disabled. Alternatively, multiple bits may be signaled to indicate which DMRS format is to be used.

The performance of the DMRS format in FIG. 5 in terms of BLER, throughput, and PAPR will now be considered based on simulations that have been conducted to show the benefit of the new DMRS format.

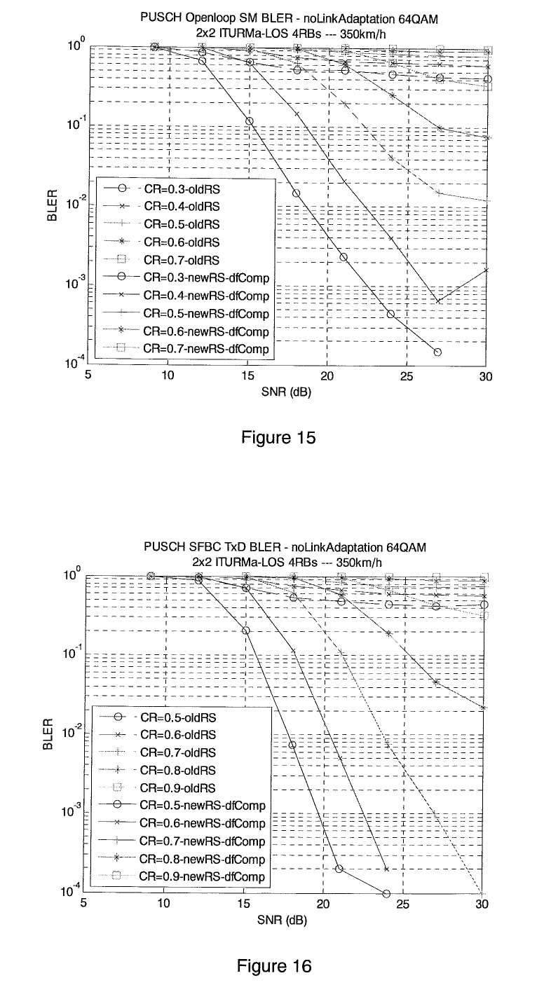

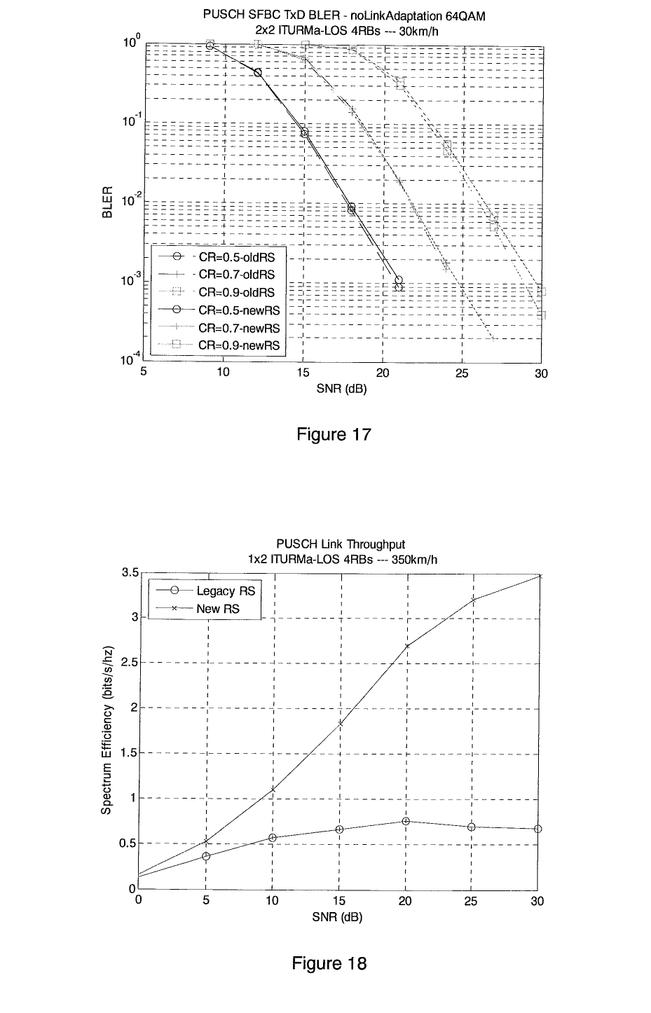

FIG. 15 and FIG. 16 compare the BLER performances of the current DMRS format and the new DMRS format for 2×2 open-loop SM and SFBC transmit diversity (T×D), respectively. A UE speed of 350 km/h and a carrier frequency of 2.6 GHz are assumed, and 64QAM with code rates from 0.3 to 0.7 for open-loop SM, or 0.5 to 0.9 for SFBC T×D, are simulated. Significant BLER improvements can be observed from the figures. The performance of the new DMRS format at low speed was also evaluated to ensure that use of the new DMRS format does not cause a significant downgrade in BLER performance at low speeds compared to the BLER performance provided by the current DMRS format at low speeds. As FIG. 17 shows, the new DMRS format performs closely to the current LTE DMRS format at a speed of 30 km/h.

FIG. 18 compares the throughput performances of the legacy DMRS format and the new DMRS format. A UE speed of 350 km/h, a carrier frequency of 2.6 GHz, and a 1×2 PUSCH transmission are assumed. Link adaptation is enabled in the simulation. From the figure it may be observed that the new DMRS format provides significant throughput gain, especially at medium and high SNRs. This superior performance is due to the ability of the new DMRS format to support high MCSs. As mentioned above, the legacy DMRS format cannot even support moderate MCSs, and hence the throughputs become constrained severely at medium and high SNRs.

In the embodiments disclosed herein, the DMRS symbol does not use SC-FDMA as it interleaves RS and data together. From the viewpoint of PAPR, the transmitted signal of the symbol containing DMRS is equivalent to the sum of two single-carrier signals, with one corresponding to RS and the other to data. As a result, the DMRS symbol may have a higher PAPR than either the data symbol or the RS signal. However, since the PAPR of the RS signal is much lower than that of the data symbol due to the properties of the Zadoff-Chu sequence, it may be expected that the PAPR of the DMRS symbol may be only slightly higher than that of the data symbol.

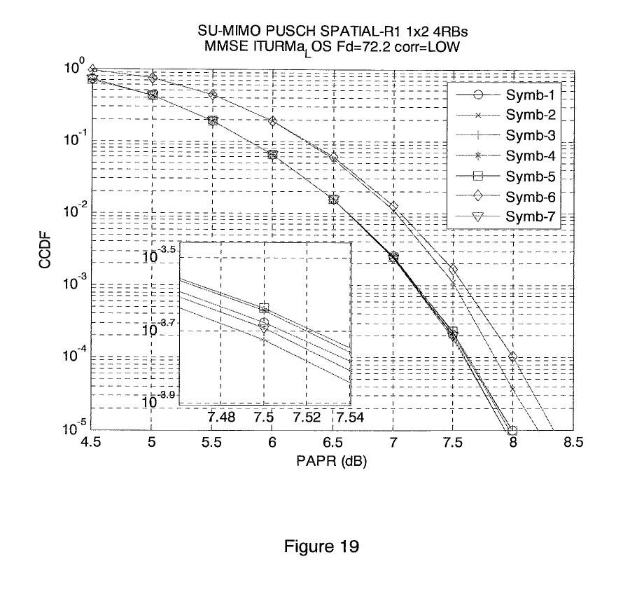

FIG. 19 shows the PAPR CCDF (complementary cumulative distribution functions) of each symbol in a slot, assuming QPSK data transmission. The five closely spaced curves in the lower part of the figure correspond to the PAPRs of the five data symbols. The two closely spaced curves in the upper part of the figure correspond to the PAPRs of the two DMRS symbols. As expected, it can be observed that the PAPR of the DMRS symbol is higher than that of the data symbol by a small amount of approximately 0.3-0.4 dB. For power-limited, cell-edge UEs, such a slightly higher PAPR in the DMRS symbol is not a desirable feature. However, for non-power-limited UEs and mobile relay backhauls, such a slightly higher PAPR is acceptable, especially considering the significant throughput improvement the new DMRS format provides.

A DMRS symbol following the new DMRS format could experience intra-cell or inter-cell interference from a data symbol if a UE with the new DMRS format and a legacy UE are scheduled to transmit on the same RB. In such cases, interference suppression and channel estimation may not occur as efficiently as in current LTE systems when a DMRS symbol collides with another DMRS symbol. This could lead to performance degradation for advanced UEs using the new DMRS format as well as for legacy UEs. In an embodiment, for scenarios without tight power constraints, power boosting on DMRS symbols or power boosting on DMRS REs may be used to compensate for the imperfect interference suppression. Alternatively, to avoid a DMRS symbol colliding with a data symbol in the case of intra-cell MU-MIMO, the eNB may schedule two UEs with the same DMRS format. To avoid inter-cell interference, neighboring cells may be coordinated so that UEs with the same DMRS format are scheduled in the same RB region.

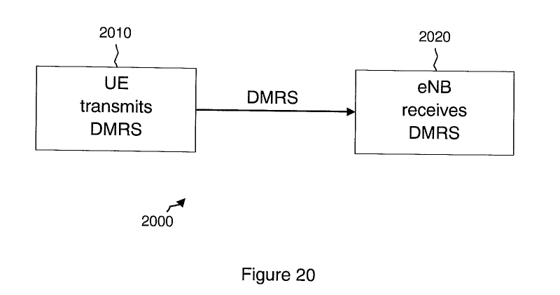

FIG. 20 illustrates an embodiment of a method 2000 for communication in a wireless telecommunication system. At block 2010, a UE transmits a DMRS, wherein REs carrying the DMRS are separated into a plurality of portions. Each of the portions occupies a different OFDM symbol in a single slot of a radio subframe. At block 2020, an eNB receives the DMRS and takes appropriate action with the DMRS.

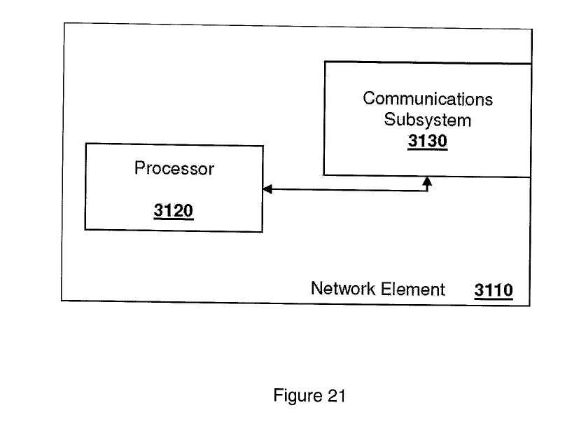

The above may be implemented by a network element. A simplified network element is shown with regard to FIG. 21. In FIG. 21, network element 3110 includes a processor 3120 and a communications subsystem 3130, where the processor 3120 and communications subsystem 3130 cooperate to perform the methods described above.

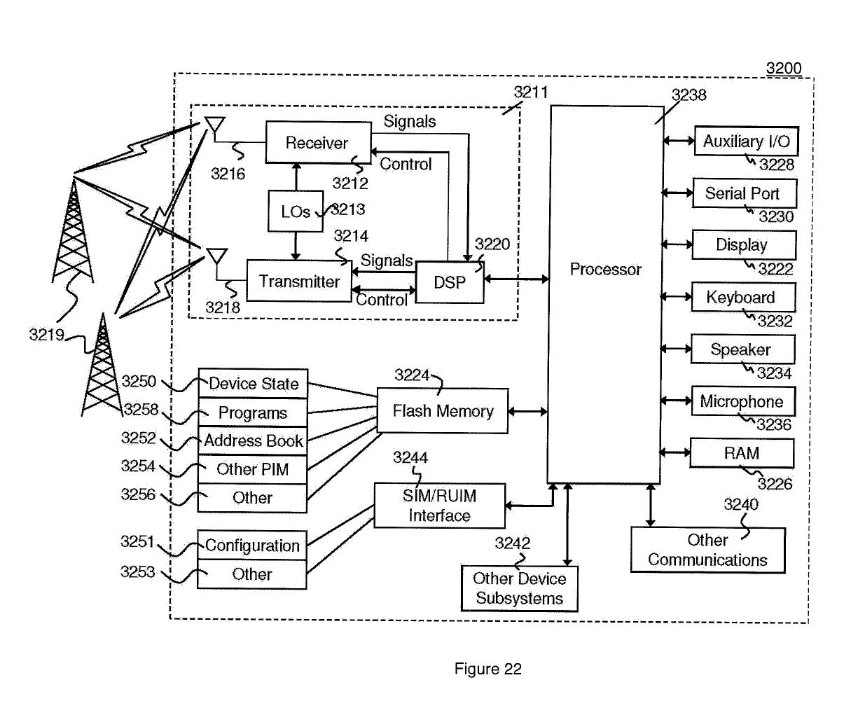

Further, the above may be implemented by a UE. An example of a UE is described below with regard to FIG. 22. UE 3200 may comprise a two-way wireless communication device having voice and data communication capabilities. In some embodiments, voice communication capabilities are optional. The UE 3200 generally has the capability to communicate with other computer systems on the Internet. Depending on the exact functionality provided, the UE 3200 may be referred to as a data messaging device, a two-way pager, a wireless e-mail device, a cellular telephone with data messaging capabilities, a wireless Internet appliance, a wireless device, a smart phone, a mobile device, or a data communication device, as examples.

Where the UE 3200 is enabled for two-way communication, it may incorporate a communication subsystem 3211, including a receiver 3212 and a transmitter 3214, as well as associated components such as one or more antenna elements 3216 and 3218, local oscillators (LOs) 3213, and a processing module such as a digital signal processor (DSP) 3220. The particular design of the communication subsystem 3211 may be dependent upon the communication network in which the UE 3200 is intended to operate.

Network access requirements may also vary depending upon the type of network 3219. In some networks, network access is associated with a subscriber or user of the UE 3200. The UE 3200 may require a removable user identity module (RUIM) or a subscriber identity module (SIM) card in order to operate on a network. The SIM/RUIM interface 3244 is typically similar to a card slot into which a SIM/RUIM card may be inserted. The SIM/RUIM card may have memory and may hold many key configurations 3251 and other information 3253, such as identification and subscriber-related information.

When required network registration or activation procedures have been completed, the UE 3200 may send and receive communication signals over the network 3219. As illustrated, the network 3219 may consist of multiple base stations communicating with the UE 3200.

Signals received by antenna 3216 through communication network 3219 are input to receiver 3212, which may perform such common receiver functions as signal amplification, frequency down conversion, filtering, channel selection, and the like. Analog to digital (A/D) conversion of a received signal allows more complex communication functions, such as demodulation and decoding to be performed in the DSP 3220. In a similar manner, signals to be transmitted are processed, including modulation and encoding for example, by DSP 3220 and are input to transmitter 3214 for digital to analog (D/A) conversion, frequency up conversion, filtering, amplification, and transmission over the communication network 3219 via antenna 3218. DSP 3220 not only processes communication signals but also provides for receiver and transmitter control. For example, the gains applied to communication signals in receiver 3212 and transmitter 3214 may be adaptively controlled through automatic gain control algorithms implemented in DSP 3220.

The UE 3200 generally includes a processor 3238 which controls the overall operation of the device. Communication functions, including data and voice communications, are performed through communication subsystem 3211. Processor 3238 also interacts with further device subsystems such as the display 3222, flash memory 3224, random access memory (RAM) 3226, auxiliary input/output (I/O) subsystems 3228, serial port 3230, one or more keyboards or keypads 3232, speaker 3234, microphone 3236, other communication subsystem 3240 such as a short-range communications subsystem, and any other device subsystems generally designated as 3242. Serial port 3230 may include a USB port or other port currently known or developed in the future.

Some of the illustrated subsystems perform communication-related functions, whereas other subsystems may provide “resident” or on-device functions. Notably, some subsystems, such as keyboard 3232 and display 3222, for example, may be used for both communication-related functions, such as entering a text message for transmission over a communication network, and device-resident functions, such as a calculator or task list.

Operating system software used by the processor 3238 may be stored in a persistent store such as flash memory 3224, which may instead be a read-only memory (ROM) or similar storage element (not shown). The operating system, specific device applications, or parts thereof, may be temporarily loaded into a volatile memory such as RAM 3226. Received communication signals may also be stored in RAM 3226.

As shown, flash memory 3224 may be segregated into different areas for both computer programs 3258 and program data storage 3250, 3252, 3254 and 3256. These different storage types indicate that each program may allocate a portion of flash memory 3224 for their own data storage requirements. Processor 3238, in addition to its operating system functions, may enable execution of software applications on the UE 3200. A predetermined set of applications that control basic operations, including at least data and voice communication applications for example, may typically be installed on the UE 3200 during manufacturing. Other applications may be installed subsequently or dynamically.

Applications and software may be stored on any computer-readable storage medium. The computer-readable storage medium may be tangible or in a transitory/non-transitory medium such as optical (e.g., CD, DVD, etc.), magnetic (e.g., tape), or other memory currently known or developed in the future.

One software application may be a personal information manager (PIM) application having the ability to organize and manage data items relating to the user of the UE 3200 such as, but not limited to, e-mail, calendar events, voice mails, appointments, and task items. One or more memory stores may be available on the UE 3200 to facilitate storage of PIM data items. Such a PIM application may have the ability to send and receive data items via the wireless network 3219. Further applications may also be loaded onto the UE 3200 through the network 3219, an auxiliary I/O subsystem 3228, serial port 3230, short-range communications subsystem 3240, or any other suitable subsystem 3242, and installed by a user in the RAM 3226 or a non-volatile store (not shown) for execution by the processor 3238. Such flexibility in application installation may increase the functionality of the UE 3200 and may provide enhanced on-device functions, communication-related functions, or both. For example, secure communication applications may enable electronic commerce functions and other such financial transactions to be performed using the UE 3200.

In a data communication mode, a received signal such as a text message or web page download may be processed by the communication subsystem 3211 and input to the processor 3238, which may further process the received signal for output to the display 3222, or alternatively to an auxiliary I/O device 3228.

A user of the UE 3200 may also compose data items, such as email messages for example, using the keyboard 3232, which may be a complete alphanumeric keyboard or telephone-type keypad, among others, in conjunction with the display 3222 and possibly an auxiliary I/O device 3228. Such composed items may then be transmitted over a communication network through the communication subsystem 3211.

For voice communications, overall operation of the UE 3200 is similar, except that received signals may typically be output to a speaker 3234 and signals for transmission may be generated by a microphone 3236. Alternative voice or audio I/O subsystems, such as a voice message recording subsystem, may also be implemented on the UE 3200. Although voice or audio signal output may be accomplished primarily through the speaker 3234, display 3222 may also be used to provide an indication of the identity of a calling party, the duration of a voice call, or other voice call-related information, for example.

Serial port 3230 may be implemented in a personal digital assistant (PDA)-type device for which synchronization with a user's desktop computer (not shown) may be desirable, but such a port is an optional device component. Such a port 3230 may enable a user to set preferences through an external device or software application and may extend the capabilities of the UE 3200 by providing for information or software downloads to the UE 3200 other than through a wireless communication network. The alternate download path may, for example, be used to load an encryption key onto the UE 3200 through a direct and thus reliable and trusted connection to thereby enable secure device communication. Serial port 3230 may further be used to connect the device to a computer to act as a modem.

Other communications subsystems 3240, such as a short-range communications subsystem, are further optional components which may provide for communication between the UE 3200 and different systems or devices, which need not necessarily be similar devices. For example, the subsystem 3240 may include an infrared device and associated circuits and components or a Bluetooth™ communication module to provide for communication with similarly enabled systems and devices. Subsystem 3240 may further include non-cellular communications such as WiFi, WiMAX, near field communication (NFC), and/or radio frequency identification (RFID). The other communications element 3240 may also be used to communicate with auxiliary devices such as tablet displays, keyboards or projectors.

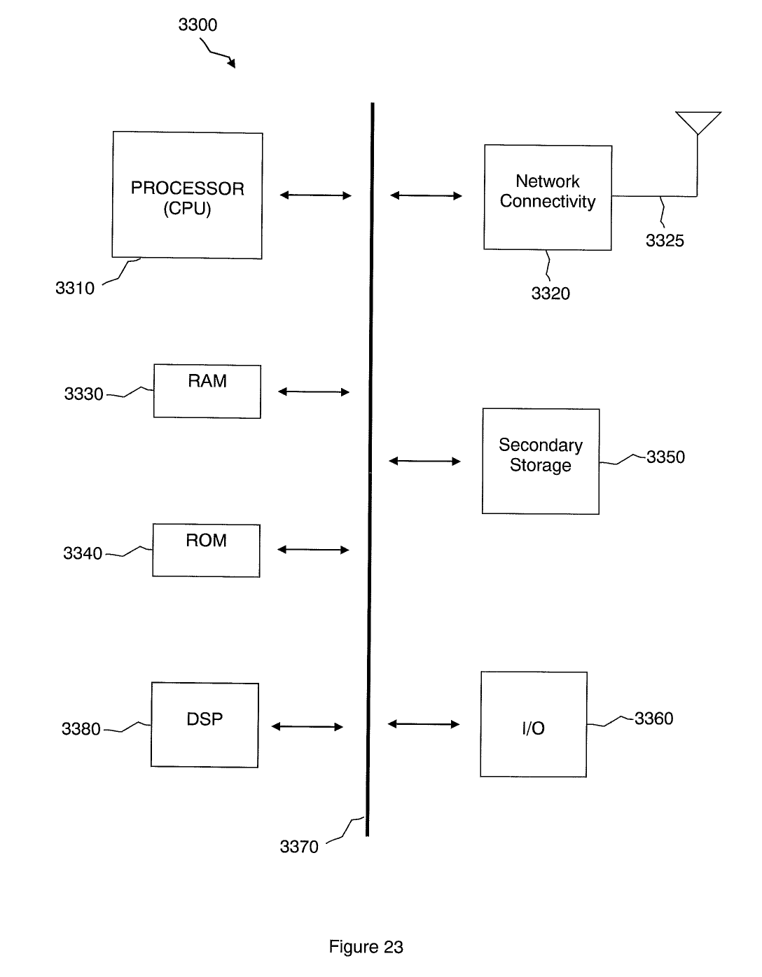

The UE and other components described above might include a processing component that is capable of executing instructions related to the actions described above. FIG. 23 illustrates an example of a system 3300 that includes a processing component 3310 suitable for implementing one or more embodiments disclosed herein. In addition to the processor 3310 (which may be referred to as a central processor unit or CPU), the system 3300 might include network connectivity devices 3320, random access memory (RAM) 3330, read only memory (ROM) 3340, secondary storage 3350, and input/output (I/O) devices 3360. These components might communicate with one another via a bus 3370. In some cases, some of these components may not be present or may be combined in various combinations with one another or with other components not shown. These components might be located in a single physical entity or in more than one physical entity. Any actions described herein as being taken by the processor 3310 might be taken by the processor 3310 alone or by the processor 3310 in conjunction with one or more components shown or not shown in the drawing, such as a digital signal processor (DSP) 3380. Although the DSP 3380 is shown as a separate component, the DSP 3380 might be incorporated into the processor 3310.

The processor 3310 executes instructions, codes, computer programs, or scripts that it might access from the network connectivity devices 3320, RAM 3330, ROM 3340, or secondary storage 3350 (which might include various disk-based systems such as hard disk, floppy disk, or optical disk). While only one CPU 3310 is shown, multiple processors may be present. Thus, while instructions may be discussed as being executed by a processor, the instructions may be executed simultaneously, serially, or otherwise by one or multiple processors. The processor 3310 may be implemented as one or more CPU chips.

The network connectivity devices 3320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 3320 may enable the processor 3310 to communicate with the Internet or one or more telecommunications networks or other networks from which the processor 3310 might receive information or to which the processor 3310 might output information. The network connectivity devices 3320 might also include one or more transceiver components 3325 capable of transmitting and/or receiving data wirelessly.

The RAM 3330 might be used to store volatile data and perhaps to store instructions that are executed by the processor 3310. The ROM 3340 is a non-volatile memory device that typically has a smaller memory capacity than the memory capacity of the secondary storage 3350. ROM 3340 might be used to store instructions and perhaps data that are read during execution of the instructions. Access to both RAM 3330 and ROM 3340 is typically faster than to secondary storage 3350. The secondary storage 3350 is typically comprised of one or more disk drives or tape drives and might be used for non-volatile storage of data or as an over-flow data storage device if RAM 3330 is not large enough to hold all working data. Secondary storage 3350 may be used to store programs that are loaded into RAM 3330 when such programs are selected for execution.

The I/O devices 3360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 3325 might be considered to be a component of the I/O devices 3360 instead of or in addition to being a component of the network connectivity devices 3320.

The following are incorporated herein by reference for all purposes: 3GPP TS 36.211, 3GPP TS 36.212, and 3GPP TS 36.331.

In an embodiment, a method for communication in a wireless telecommunication system is provided. The method comprises transmitting, by a UE, a DMRS, wherein REs carrying the DMRS are separated into a plurality of portions, each of the portions occupying a different OFDM symbol in a single slot of a radio subframe.

The method may further include that in an OFDM symbol occupied by one of the portions, REs that are not used for carrying the DMRS may be used for carrying data. Data symbols may be Discrete Fourier Transform (DFT) precoded and subsequently mapped on to the REs that are not used for carrying the DMRS. The length of the DFT may be equal to the number of data symbols.

In one embodiment of the method, the REs carrying the DMRS may be separated into two portions with six REs in each portion, and wherein REs in a first portion may occupy even numbered subcarriers in the slot and REs in a second portion may occupy odd numbered subcarriers in the slot, and wherein OFDM symbols carrying the DMRS may be separated by one, two, three, or more OFDM symbols carrying data. In another embodiment, the REs carrying the DMRS may be separated into two portions with six REs in each portion, and wherein REs in each portion may occupy the same subcarriers, and wherein the subcarriers carrying the DMRS may be separated by a subcarrier carrying data, and wherein OFDM symbols carrying the DMRS may be separated by one, two, three, or more OFDM symbols carrying data. In another embodiment, the REs carrying the DMRS may be separated into three portions with four REs in each portion, and wherein all of the REs carrying the DMRS may occupy different subcarriers, and wherein OFDM symbols carrying the DMRS may be separated by at least one OFDM symbol carrying data. In another embodiment, the REs carrying the DMRS may be separated into four portions with three REs in each portion, and wherein all of the REs carrying the DMRS may occupy different subcarriers, and wherein OFDM symbols carrying the DMRS may be separated by at least one OFDM symbol carrying data. In another embodiment, the REs carrying the DMRS may be separated into four portions with three REs in each portion, and wherein REs in two of the portions may occupy carriers starting from the first subcarrier and REs in another two of the portions may occupy carriers starting from the second subcarrier, and wherein the two subcarriers may be separated by a subcarrier carrying data, and wherein OFDM symbols carrying the DMRS may be separated by at least one OFDM symbol carrying data.

As an example, for the case that the DMRS are divided into two portions, the method may also entail that a DMRS sequence may have a length of half of the number of subcarriers of physical uplink shared channel (PUSCH). The method may use a cyclic shift α_{λ} in a slot nₛ to generate a DMRS sequence that may be defined as α_{λ}=2πn_{cs,λ}/6 with n_{cs,λ}=(n_{DMRS}⁽¹⁾+n_{DMRS,λ}⁽²⁾+n_{PN}(nₛ))mod 6. Within the method, an orthogonal cover code (OCC) may be applied to the plurality of portions in the slot and the same OCC may be repeated in a second slot of the subframe.

Within the method, the UE may receive information regarding a pattern of the plurality of portions via at least one of: radio resource control signaling; or a Layer 1 uplink grant; or a medium access control (MAC) control element. When the UE receives the information regarding the pattern of the plurality of portions via radio resource control signaling, the information may be received in a parameter in a PUSCH-ConfigDedicated information element. The parameter may be one of: a single-bit parameter specifying whether or not a pre-specified pattern of the plurality of portions is to be used; or a multiple-bit parameter specifying which one of a plurality of patterns of the plurality of portions is to be used.

In another embodiment, a UE is provided. The UE comprises a transmitter configured to transmit a DMRS, wherein the DMRS occupies at least two OFDM symbols in a single slot of a radio subframe, and wherein each of the at least two OFDM symbols comprises REs carrying the DMRS interleaved in the frequency domain with REs carrying data.

In another embodiment, a network element is provided. The network element comprises a receiver configured to receive a plurality of REs carrying a DMRS, wherein the plurality of REs are received in a plurality of OFDM symbols in a single slot of a radio subframe. The UE and network element may be used in performing the methods described herein.

For example, the network element may receive an OFDM symbol carrying a portion of the DMRS. The network element may perform an M-point fast Fourier transform (FFT) on the OFDM symbol, where M is an FFT size corresponding to a system bandwidth, and wherein the network element separates the data from the DMRS. The network element may transmit information regarding a pattern of the plurality of REs via at least one of: radio resource control signaling; or a Layer 1 uplink grant; or a medium access control (MAC) control element. The network element may transmit the information regarding the pattern of the plurality of REs of a user equipment (UE) to another network element when the network element possesses information indicating that the UE is moving at a high speed and/or being handed over to another network element.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for communication in a wireless telecommunication system, the method comprising:
transmitting, by a user equipment (UE), a demodulation reference signal (DMRS), wherein resource elements (REs) carrying the DMRS are separated into a plurality of portions, each of the portions occupying a different orthogonal frequency division multiplexing (OFDM) symbol in a single slot of a radio subframe.

2. The method of claim 1, wherein, in an OFDM symbol occupied by one of the portions, REs not used for carrying the DMRS are used for carrying data.

3. The method of claim 1, wherein, in the OFDM symbol occupied by one of the portions, the data symbols are Discrete Fourier Transform (DFT) precoded and subsequently mapped on to the REs that are not used for carrying the DMRS.

4. The method of claim 3, wherein the length of the DFT is equal to the number of data symbols.

5. The method of claim 1, wherein the REs carrying the DMRS are separated into two portions with six REs in each portion, and wherein REs in a first portion occupy even numbered subcarriers in the slot and REs in a second portion occupy odd numbered subcarriers in the slot, and wherein OFDM symbols carrying the DMRS are separated by at least one OFDM symbol.

6. The method of claim 1, wherein the REs carrying the DMRS are separated into two portions with six REs in each portion, and wherein REs in each portion occupy the same subcarriers, and wherein the subcarriers carrying the DMRS are separated by a subcarrier carrying data, and wherein OFDM symbols carrying the DMRS are separated by at least one OFDM symbol.

7. The method of claim 1, wherein the REs carrying the DMRS are separated into three portions with four REs in each portion, and wherein all of the REs carrying the DMRS occupy different subcarriers, and wherein OFDM symbols carrying the DMRS are separated by at least one OFDM symbol.

8. The method of claim 1, wherein the REs carrying the DMRS are separated into four portions with three REs in each portion, and wherein all of the REs carrying the DMRS occupy different or same subcarriers, and wherein OFDM symbols carrying the DMRS are separated by at least one OFDM symbol.

9. The method of claim 1, wherein a DMRS sequence has a length of half of the number of subcarriers of a physical uplink shared channel (PUSCH).

10. The method of claim 1, wherein a cyclic shift α_{λ} in a slot nₛ to generate a DMRS sequence is given as α_{λ}=2πn_{cs,λ}/6 with n_{cs,λ}=(n_{DMRS}⁽¹⁾+n_{DMRSλ}⁽²⁾+n_{PN}(nₛ))mod 6.

11. The method of claim 1, wherein an orthogonal cover code (OCC) is applied to the plurality of portions in the slot.

12. The method of claim 11, wherein the same OCC is repeated in a second slot of the subframe.

13. The method of claim 1, wherein the UE receives information regarding a pattern of the plurality of portions via one of:
radio resource control signaling; and
a Layer 1 resource grant; and
a medium access control (MAC) control element.

14. The method of claim 13, wherein, when the UE receives the information regarding the pattern of the plurality of portions via radio resource control signaling, the information is received in a parameter in a PUSCH-ConfigDedicated information element.

15. The method of claim 13, wherein the parameter is one of:
a single-bit parameter specifying whether a pre-defined pattern of the plurality of portions is used; and
a multiple-bit parameter specifying which one of a plurality of patterns of the plurality of portions is used.

16. A user equipment (UE) comprising:
a transmitter configured to transmit a demodulation reference signal (DMRS), wherein the DMRS occupies at least two orthogonal frequency division multiplexing (OFDM) symbols in a single slot of a radio subframe, and wherein each of the at least two OFDM symbols comprises resource elements (REs) carrying the DMRS interleaved in the frequency domain with REs carrying data.

17. The UE of claim 16, wherein, in an OFDM occupied by one of the portions of the DMRS, the data are Discrete Fourier Transform (DFT) precoded and subsequently mapped on to the REs that are not used for carrying the DMRS.

18. The UE of claim 16, wherein the length of the DFT is equal to the number of data symbols.

19. The UE of claim 16, wherein the REs carrying the DMRS are separated into two portions with six REs in each portion, and wherein REs in a first portion occupy even numbered subcarriers in the slot and REs in a second portion occupy odd numbered subcarriers in the slot, and wherein OFDM symbols carrying the DMRS are separated by at least one OFDM symbol carrying data.

20. The UE of claim 16, wherein the REs carrying the DMRS are separated into two portions with six REs in each portion, and wherein REs in each portion occupy the same subcarriers, and wherein the subcarriers carrying the DMRS are separated by a subcarrier carrying data, and wherein OFDM symbols carrying the DMRS are separated by at least one OFDM symbol carrying data.

21. The UE of claim 16, wherein the REs carrying the DMRS are separated into three portions with four REs in each portion, and wherein all of the REs carrying the DMRS occupy different subcarriers, and wherein OFDM symbols carrying the DMRS are separated by at least one OFDM symbol carrying data.

22. The UE of claim 16, wherein the REs carrying the DMRS are separated into four portions with three REs in each portion, and wherein all of the REs carrying the DMRS occupy different or same subcarriers, and wherein OFDM symbols carrying the DMRS are separated by at least one OFDM symbol carrying data.

23. The UE of claim 16, wherein the UE performs N/2-point fast Fourier transform (FFT) on data to be transmitted, where N is the number of physical uplink shared channel subcarriers, and wherein the UE multiplexes the data with the DMRS, and wherein the UE performs M-point inverse FFT (IFFT) on the multiplexed data and DMRS, where M is an IFFT size corresponding to a system bandwidth.

24. The UE of claim 16, wherein, when the UE possesses information indicating that the UE is moving at a high speed, the UE transmits a request to use a DMRS that occupies at least two OFDM symbols in a single slot of a radio subframe.

25. A network element comprising:
a receiver configured to receive a plurality of resource elements (REs) carrying a demodulation reference signal (DMRS), wherein the plurality of REs are received in a plurality of orthogonal frequency division multiplexing (OFDM) symbols in a single slot of a radio subframe.

26. The network element of claim 25, wherein the plurality of REs are interleaved in the frequency domain with REs carrying data.

27. The network element of claim 25, wherein the network element transmits the information regarding the pattern of the plurality of REs to a user equipment (UE) when the network element possesses information indicating that the UE is moving at a high speed.

28. The network element of claim 25, wherein the network element transmits the information regarding the pattern of the plurality of REs to a user equipment (UE) in a handover Command message when the network element possesses information indicating that the UE is being handed over to another network element.

29. The network element of claim 25, wherein the network element transmits the information regarding the pattern of the plurality of REs of a user equipment (UE) to another network element when the network element possesses information indicating that the UE is being handed over to another network element.
